(19) United States
(12) Patent Application Publication
(10) Pub. No.: US 2024/0144822 A1
(43) Pub. Date: May 2, 2024

(54) Interactive Routing

(71) Applicant: Apple Inc., Cupertino, CA (US)

(72) Inventors: Daniel De Rocha Rosario, San Francisco, CA (US); Kurt R Stiehl, Los Gatos, CA (US); Matthew J Allen, Menlo Park, CA (US); David A Krimsley, Sunnyvale, CA (US); Kevin M Lynch, Woodside, CA (US)

(21) Appl. No.: 18/404,603

(22) Filed: Jan. 4, 2024

Related U.S. Application Data
(63) Continuation of application No. PCT/US22/35570, filed on Jun. 29, 2022.
(60) Provisional application No. 63/220,693, filed on Jul. 12, 2021.

(51) Int. Cl. G08G 1/0969; G01C 21/36; G06F 3/044; G06F 3/0488

(52) U.S. Cl. CPC G08G 1/0969; G01C 21/367; G01C 21/3676; G06F 3/044; G06F 3/0488

(57) ABSTRACT

A vehicle may have devices such as knobs, sliders, touch sensors, cameras, and other devices for gathering user input, capturing images, and gathering other information. Control circuitry in the vehicle may display an interactive route map on a display in the vehicle body. The route map may have a route line depicting a route between a starting point and an ending point for a journey. The control circuitry may move a vehicle icon in forward and reverse along the route line in response to the user input to select a vehicle icon location. The control circuitry may display media that corresponds to the selected vehicle icon location. The media may include an image captured by the camera, media retrieved from remote databases, and/or other content associated with the location of the vehicle icon.

This application is a continuation of international patent application No. PCT/US22/35570, filed Jun. 29, 2022, which claims priority to U.S. provisional patent application No. 63/220,693, filed Jul. 12, 2021, which are hereby incorporated by reference herein in their entireties.

### FIELD

This relates generally to systems such as vehicles, and, more particularly, vehicles that have displays.

### BACKGROUND

Automobiles and other vehicles have propulsion and steering systems. Displays are used to provide vehicle occupants with visual output.

### SUMMARY

A vehicle may have a vehicle body and a steering and propulsion system for driving the vehicle along a road. Control circuitry in the vehicle may use the steering and propulsion system to drive the vehicle autonomously. To provide a user of the vehicle with information on a journey, a route map may be displayed by the control circuitry using a display in the vehicle body.

The vehicle may have devices such as knobs, sliders, touch sensors, cameras, and other devices for gathering user input, capturing images, and gathering other information. The control circuitry may use information gathered by these devices in presenting the route map.

The route map on the display may have a route line depicting a route between a starting point and an ending point for a journey. The control circuitry may move a vehicle icon in forward and reverse directions along the route line in response to gathered user input. In this way, a user may select a desired vehicle icon location corresponding to the vehicle's current location, an earlier location along the route, or a future location along the route. The control circuitry may display media that corresponds to the selected location of the vehicle icon along the route line. The media may include an image captured by a camera in the vehicle at a location corresponding to the selected location of the vehicle icon along the route line, may include information on traffic conditions, points of interest, vehicle stopping options, and other information associated with the vehicle icon location.

### BRIEF DESCRIPTION OF THE DRAWINGS

FIG. 1 is a schematic diagram of an illustrative vehicle in accordance with an embodiment.

FIG. 2 is a diagram of an illustrative vehicle display and associated controls for the display that may be located in an interior region of a vehicle body in accordance with an embodiment.

FIG. 3 is a diagram of an illustrative vehicle display configured to display route information in accordance with an embodiment.

FIG. 4 is a diagram of an illustrative vehicle display configured to display images such as interactive 360° images associated with a driving route for a vehicle in accordance with an embodiment.

FIG. 5 is a diagram of an illustrative vehicle display configured to display interactive route options such as stopping location options in accordance with an embodiment.

FIG. 6 is a diagram of an illustrative vehicle display configured to display a route with a selectable segment of interest in accordance with an embodiment.

FIG. 7 is a diagram of an illustrative vehicle display with an annotated route map, an annotated portion of a route map with selectable points of interest, and associated detailed information on a selected one of the points of interest in accordance with an embodiment.

FIG. 8 is a diagram of an illustrative vehicle display configured to display images of real-world road signs and associated virtual image content such as virtual road signs in accordance with an embodiment.

FIG. 9 is a diagram of an illustrative vehicle display configured to display a route map with an interactive roam zone in accordance with an embodiment.

FIG. 10 is a diagram showing illustrative operations involved in using a system in accordance with an embodiment.

### DETAILED DESCRIPTION

A vehicle may have output devices such as displays. An interactive route map may be presented on a display. A vehicle occupant may interact with the route map. For example, a user of the route map may move a vehicle icon to previous points along a route, effectively going back in time. Roadside images and other media associated with previous route positions may be presented as the user travels back in time. If desired, the user may move in a forward direction through the route so that aspects of the route at times in the future may be explored. If, as an example, a user is interested in examining portions of the route ten minutes in the future, the user may move the vehicle icon to an appropriate point further along the route. Media associated with this future route position may then be presented to the user. An interactive map application may be used to presented the user with the interactive route map. A user may control the map using knobs, sliders, on-screen options, voice commands, and/or other user input. The interactive map application may gather media from vehicle sensors, databases, and/or other sources.

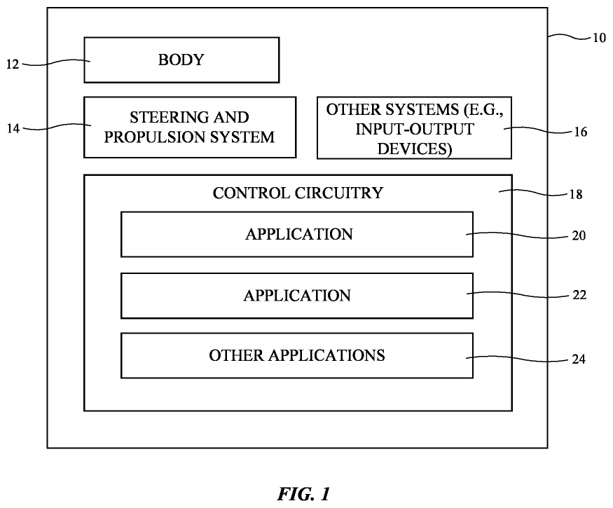

FIG. 1 is a schematic diagram of an illustrative vehicle that may include one or more displays for presenting an interactive route map to a user. In the example of FIG. 1, vehicle 10 is the type of vehicle that may carry people on a roadway (e.g., an automobile, truck, or other automotive vehicle). Vehicle occupants, who may sometimes be referred to as users, may include drivers and passengers.

Vehicle 10 may be manually driven (e.g., by a human driver), may be operated via remote control, and/or may be autonomously operated (e.g., by an autonomous driving system). Vehicle 10 may include a body such as body 12. Body 12 may include vehicle structures such as body panels formed from metal and/or other materials, may include doors, a hood, a trunk, fenders, a chassis to which wheels are mounted, a roof, etc. Doors in body 12 may be opened and closed to allow people to enter and exit vehicle 10. Seats and other structures may be formed in an interior region within body 12. Windows may be formed in doors and other portions of body 12. Windows, doors, and other portions of body 12 may separate the interior region where vehicle occupants are located from the exterior environment that is surrounding vehicle 10.

Vehicle 10 may include steering and propulsion system 14. System 14 may include manually adjustable driving systems and/or autonomous driving systems having wheels coupled to body 12, steering controls, motors, etc.) and may include other vehicle systems.

Vehicle 10 may also include control circuitry 18 and other systems 16. Control circuitry 18 may be configured to implement autonomous driving application 20, interactive route map application 22, and other applications 24 (e.g., applications for adjusting lights, media playback, sensor operation, climate controls, windows, and other vehicle functions). Control circuitry 18 may include processing circuitry and storage. Control circuitry 12 may be configured to perform operations in vehicle 10 using hardware (e.g., dedicated hardware or circuitry), firmware and/or software. Software code for performing operations in vehicle 10 and other data is stored on non-transitory computer readable storage media (e.g., tangible computer readable storage media) in control circuitry 18. The software code may sometimes be referred to as software, data, program instructions, computer instructions, instructions, or code. The non-transitory computer readable storage media may include non-volatile memory such as non-volatile random-access memory, one or more hard drives (e.g., magnetic drives or solid state drives), one or more removable flash drives or other removable media, or other storage. Software stored on the non-transitory computer readable storage media may be executed on the processing circuitry of control circuitry 18. The processing circuitry may include application-specific integrated circuits with processing circuitry, one or more microprocessors, a central processing unit (CPU) or other processing circuitry.

The input-output devices of systems 16 may include displays, sensors, buttons, light-emitting diodes and other light-emitting devices, haptic output devices, speakers, and/or other devices for gathering sensor measurements on the environment in which vehicle 10 is operating and/or for gathering user input. The sensors may include ambient light sensors, touch sensors, force sensors, proximity sensors, optical sensors such as cameras operating at visible, infrared, and/or ultraviolet wavelengths (e.g., fisheye cameras and/or other cameras), capacitive sensors, resistive sensors, ultrasonic sensors (e.g., ultrasonic distance sensors), microphones, three-dimensional and/or two-dimensional images sensors, radio-frequency sensors such as radar sensors, lidar (light detection and ranging) sensors, and/or other sensors. Sensors may be mounted in vehicle 10 in one or more locations such as outwardly facing locations (locations facing in the normal forward direction of travel of vehicle 10, locations facing rearward, locations facing outwardly from the left and right sides of vehicle 10, locations facing towards the interior of vehicle 10, etc.). Output devices in systems 16 may be used to provide vehicle occupants and others with haptic output, audio output, visual output (e.g., displayed content, light, etc.), and/or other suitable output.

During operation, control circuitry 18 may gather information from sensors and/or other input-output devices such as lidar data, camera data (images), radar data, location data (e.g., data from Global Positioning System receiver circuitry and/or other location sensing circuitry), speed data, direction of travel data (e.g., from a steering system, compass, etc.), motion data (e.g., position information and information on changes in position gathered using a compass, gyroscope, accelerometer and/or an internal measurement unit that contains one, two, or all three of these sensors), sound data (e.g., recorded sounds from the inside and outside of vehicle 10 that have been gathered using a microphone), temperature data, light intensity data (e.g., ambient light readings) and/or other sensor data. User input devices such as touch sensors, buttons, microphones for gathering voice information, force sensors, optical sensors, and other input devices may be used for gathering user input. Data may also be gathered from one or more databases. Databases may be maintained internally in vehicle 10 (e.g., in storage in control circuitry 18) and/or may be maintained remotely (e.g., on one or more servers that vehicle 10 may access). Vehicle 10 may use wireless communications circuitry (e.g., a wireless transceiver in circuitry 18 such as a cellular telephone transceiver that is configured to send and receive data wirelessly) to retrieve remote database information through the internet and/or other wide area networks, local area networks, wired and/or wireless communications paths, etc.). As an example, map data, point-of-interest data, 360° images and other image data, video clips, audio clips, and/or other media including traffic information, weather information, radio content and other streaming video and/or audio content, information on businesses, historical sites, parks, and/or other points of interest, and/or other information may be retrieved from one or more local and/or remote databases. Control circuitry 18 may use data from databases, environmental measurements, measurements on vehicle operation, and other sensor measurements and may use user input gathered from user input devices in providing a user of vehicle 10 with desired functions. As an example, these sources of data may be used as inputs to driving application 20, interactive route map application 22, and/or other applications 24.

Interactive route application 22 may be used in trip planning, setting destinations for autonomous driving application 20, retrieving historical information related to a driving route, and/or in obtaining information associated the user's present and future locations along a route. In an illustrative configuration, a user may use a knob or other user input device to move along a route on a map. The map may have a darkened line or other visual indicator that specifies the current route of vehicle 10. The user's present location along the route may be indicated by a vehicle icon or other visual indicator. Previous locations along the route (e.g., the beginning portion of the route corresponding to times in the past), the current location of vehicle 10 along the route, and future locations along the route (e.g., the portion of the route corresponding to times in the future) may be accessed.

As an example, the vehicle's current location on the route may be presented to the user by default, the user may rotate the knob counterclockwise to move the vehicle icon to earlier time periods and thereby access historical portions of the route, and the user may rotate the knob clockwise to move the vehicle icon to future portions of the route at future time periods, thereby accessing predicated portions of the route. As the user moves the vehicle icon back and forth along a line indicating a route on a map, control circuitry 18 may use the display of vehicle 10 and other output devices (e.g., speakers) to present media content to the user that is associated with the selected location of the vehicle icon along the route.

The user may select a position along the route that corresponds to the current time and location of vehicle 10 on the route, an earlier time at a previously visited location along the route, or a predicated location that is expected to be reached at a time in the future. The content that is associated with a selected route location (and time) may include images (still and/or moving images and associated audio), may include sound (e.g., audio clips), may include point-of-interest information (e.g., nearby points-of-interest within a given distance of the selected route location), may include parking locations, may include local route options, may include information retrieved from databases, may include sensor data from cameras and/or other sensors, and/or may include other content. Visual content may be overlaid on a route map, may be presented in a window or other region on the same display as the route map, may be presented in place of the route map, may be presented on an ancillary display, and/or may otherwise be visually presented to the user.

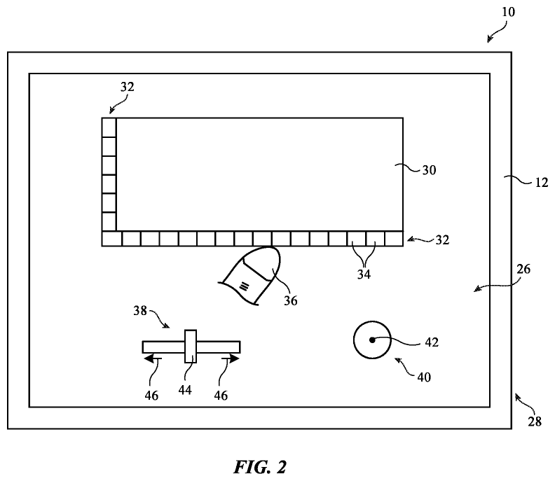

A diagram of vehicle 10 showing how body 12 may form interior region 26 in vehicle 10 and may separate interior region 26 from a surrounding exterior region 28 is shown in FIG. 2. As shown in FIG. 2, one or more displays in system 16 such as display 30 may be used to display an interactive route map and/or other content for a user. Display 30 may be an organic light-emitting diode display or other light-emitting diode display, may be a liquid crystal display, or may be any other suitable display.

Display 30 may have a two-dimensional capacitive touch sensor, an optical touch sensor, or other touch sensor overlapping the pixels of display 30 (e.g., display 30 may be a touch sensitive display) or display 30 may be insensitive to touch. Force sensors and/or other sensors may also be integrated into display 30. If desired, one or more touch sensors may be formed along one or more of the peripheral edges of display 30, as shown by illustrative touch sensors 32 on the two orthogonal edges of display 30 of FIG. 2. In an illustrative configuration, touch sensors 32 may be one-dimensional capacitive touch sensors having touch sensor electrodes 34 arranged in strips extending along one or more edges of display 30. A one-dimensional capacitive touch sensor may be formed from a strip of opaque metal electrodes (e.g., in configuration in which the sidewalls of display 30 do not contain any pixels) or may be formed from a strip of transparent conductive electrodes such as indium tin oxide electrodes (e.g., in configurations in which the one-dimensional capacitive touch sensor(s) overlaps an array of edge pixels forming a sidewall display on the outer edge of display 30).

Edge-mounted touch sensors (sometimes referred to as display edge sensors or display edge touch sensors) may be operated separately from the optional touch sensor array overlapping the pixels of display 30. As an example, a user may provide touch input to a display edge sensor using finger 36 to select a desired vehicle icon location along a travel route in an inactive map. The user may, as an example, slide finger 36 to the left along sensor 32 to move a vehicle icon on an interactive map to an earlier time and earlier position (e.g., a past time and position) along a route or may slide finger 36 to the right along sensor 32 to move the vehicle icon on the interactive map to a later time (e.g., a future time and position). By selecting a desired position for the vehicle icon along the route and thereby selecting a corresponding time (past, current, or future), the user may direct interactive route map application 22 to present content that is associated with that selected position and time. The presented content may include visual content, audio content, haptic output, and/or other output associated with a selected time and/or position in the map.

In addition to or instead of sliding finger 36 back and forth across a display edge sensor, a user may adjust a touch-sensitive interactive slider that is presented on display 30, may move slider bar 44 of physical slider 38 back and forth in directions 46, may rotate knob 40 clockwise and counterclockwise about axis 42, may use buttons to advance and rewind a vehicle icon along the route line on the interactive map, may use voice commands, air gestures, and/or other input to control the interactive map, and/or may otherwise supply user input to direct control circuitry 18 to move forward and reverse along the route in the interactive map. In general, any suitable user input may be used to control the interactive map. The user of slider-type and/or rotating input devices are presented as examples.

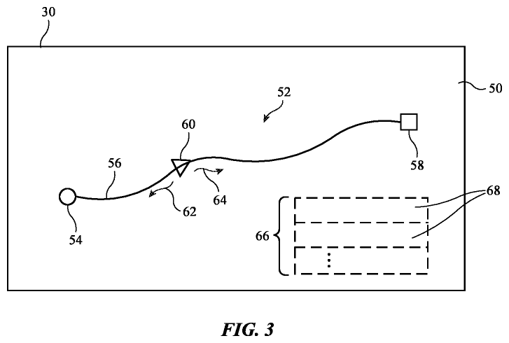

FIG. 3 is a diagram of an illustrative interactive map that may be presented on displays such as display 30 of FIG. 2. As shown in FIG. 3, map 50 may include an interactive route such as route 52. Route 52 may follow one or more roads in map 50 (e.g., highways and/or local roads). Map 50 may contain a street map on which route 52 is highlighted. Application 22 may have a navigation feature that automatically selects route 52 based on a user's known location and desired destination (e.g., application 22 may map out route 52 automatically to minimize travel time while satisfying constraints such as a user's desire to avoid highways, a user's desire to use highways, a user's desire to avoid traffic delays, etc.).

Route 52 may be depicted by dots, dashes, a highlight color, or other indicator. In the example of FIG. 3, the route is represented by route line 56. Route line 56 extends between starting point 54 (e.g., a departure location for vehicle 10) and ending point 58 (e.g., a desired destination for vehicle 10). Vehicle 10 may be represented by an indicator such as vehicle icon 60. Icon 60 may be moved back and forth along route line 56. For example, in the absence of user input, application 22 may place icon 60 on line 56 at a location that represents the current location of vehicle 10 on route 52. When a user desires to review historical information associated with the user's journey, the user may move icon 60 to an earlier position along line 56 (e.g., vehicle icon 60 may be moved to the left away from its current location to a selected position on line 56 that corresponds to an earlier part of the user's journey). For example, if the user has been traveling for an hour, the user may rotate knob 40 of FIG. 2 counterclockwise to move icon 60 to the location on map 50 that vehicle 10 drove past 15 minutes into the journey). When the user desires to view projected information corresponding to times in the future, the user may move icon 60 towards a later position along line 56 (e.g., a user may move icon 60 to the right away from its current location to a selected position along that corresponds to a future time (e.g., two hours into the journey, which is an hour in the future in this example). Application 22 may use known speed limits for the roads along route 52 and the speed of vehicle 10 to estimate the location on route 52 where vehicle 10 will be located two hours into the journey and can place icon 60 at a corresponding location on line 56.

By using knob 40 or other suitable input-output device (e.g., display edge sensor, a physical slider, voice command sensor circuitry.), the user can effectively slide icon 60 back and forth along line 56 to select a position of interest on line 56. Content may be presented to the user with display 30 (e.g., a portion of map 50), and/or other output devices (e.g., speakers) that corresponds to the selected position of icon 60 on line 56. This content may, as an example, include one or more media items 68 presented on one or more areas of display 30 (see, e.g., region 66 of map 50). The media content that is presented may include sound, haptic output, and/or other non-visual output. In general, media items that may be presented in association with a selected location of icon 60 along line 56 may include sensor data (e.g., previously captured images, previously measured temperatures and light levels, etc.), data from local and/or remote databases, and/or other suitable data.

Consider, as an example, a scenario in which a user moves icon 60 to an earlier point in route 56 than the current location of vehicle 10. Vehicle 10 has sensors such as cameras and microphones may be used to gather images and sound recordings of the interior of vehicle 10 and the environment surrounding vehicle 10. Sensors in vehicle 10 may also gather other sensor data. The measurements made by the internal and external sensors of vehicle 10 may be stored in control circuitry 18 (e.g., in a local database) and/or may be stored in a remote database.

When a user moves icon 60 to a selected previous location along line 56, application 22 may present still images and/or moving images (video) and sound captured by the sensors of vehicle 10 when vehicle 10 was located at the geographic location corresponding to the selected previous map location along line 56. If, as an example, vehicle 10 had been driving past a forest at that map location, images and sounds of the forest may be retrieved from the database in which these images and sounds were stored and may be presented as one or more media items 68. Other content associated with the selected location can also be presented (e.g., information on nearby points of interest from a map database, geographically tagged images and/or social media content associated with a map database, etc.). In this way, the user can recreate older portions of the user's journey and may browse through these older portions of the journey by using knob 40 or other user input device to select other desired previous locations along line 56.

In addition to exploring the past, the user may desire to explore the future. To do so, the user may rotate knob 40 clockwise or may use other input device to move icon 60 to a position along line 56 corresponding to an expected future location of vehicle 10 along the user's route. Application 22 can retrieve media items 68 (e.g., images, sound, social media, information on nearby points of interest, etc.) from remote and/or local databases that correspond to these selected future location. In this way, the user can explore dining options and other opportunities associated with the future location.

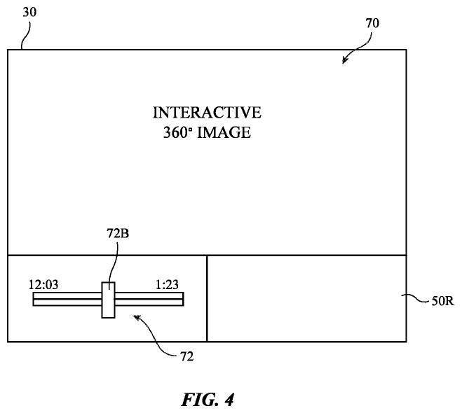

FIG. 4 shows how application 22 may, if desired, present interactive 360° images associated with route 52. Interactive map 50 of FIG. 3 may be presented in reduced-size map region 50R to provide additional area on display 30 to display interactive image 70. A user may use knob input, touch input (e.g., swipes, pinch-to-zoom and other multitouch input), slider input on a physical slider, voice commands, and/or other input to manipulate the perspective shown in image 70 (e.g., the user may supply user input to rotate image 70 through 360° to explore the surroundings of vehicle 10 when the vehicle is at a selected location along the route). The user may select a desired location for vehicle icon 60 on an interactive route map in region 50R. For example, the user may move vehicle icon 60 back and forth along line 56 in region 50R using route timeline slider 72. Slider 72 may be controlled using touch input on display 30. The left end of slider 72 may be annotated with the start time of the user's journey. The right end of slider 72 may be annotated with the projected end time of the journey. Sliding bar 72B of slider 72 may slide along slider 72 in response to touch input and may be used to move vehicle icon 60 along route line 56 (e.g., in map region 50R). In this way, the user may adjust slider 72 to select a desired time and location of interest in the journey. The selected time and location may correspond to a time in the past, the current time, or a time in the future. One or more media items (e.g., image 70 in the present example) that correspond to the location of vehicle 10 at the selected time may be presented in response to the user's adjustment of slider 70 to select the time and location of interest.

A user may desire to make adjustments to the user's planned journey. For example, a user may wish to modify the currently planned route to pass particular points of interest or may wish to make a previously unplanned stop along the planned route. At the user's destination or at one or more stops along the route, the user may desire to select a particular stopping location (e.g., a drop-off location, a pick-up location, a parking location, a location associated with a drive-through restaurant, etc.).

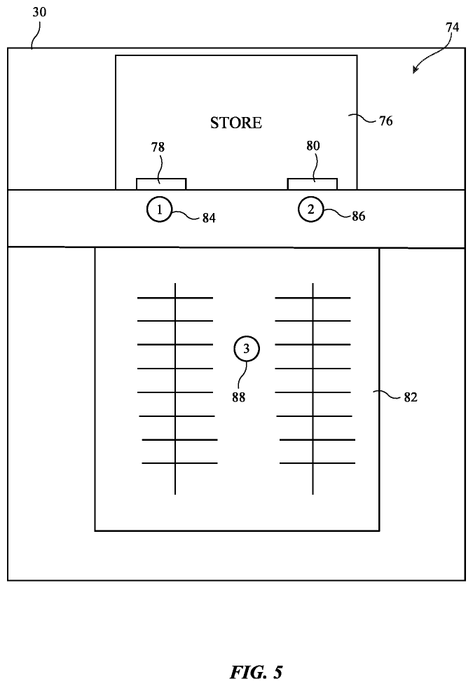

Stopping locations and other selections may be made prior to commencing the user's journey or may be deferred until after vehicle 10 is underway. As an example, a user may have a four hour route planned and may have been driving for one hour. The user may desire to stop at a store in the next 30 minutes. Using interactive map 30, the user may zoom into a segment of the user's journey (e.g., a segment of line 56 of FIG. 3) that corresponds to the next 30 minutes of travel time. Once zoomed in, the user may select the store of interest from an interactive list or set of selectable annotated map icons. In response, application 22 may present the user with a local map such as local map 74 of FIG. 5.

As shown in FIG. 5, local map 74 may contain a visual representation of the store selected by the user (store 76). A front entrance such as entrance 78 and one or more additional entrances such as side entrance 80 may be depicted. Map 74 may contain graphical representations of roads passing entrances 78 and 80 and may contain information on the layout of available parking (see, e.g., parking lot 82). Selectable icons may be presented that represent stopping options for vehicle 10. In the example of FIG. 5, these selectable stopping option icons include a front entrance stopping location icon 84, side entrance stopping location icon 86, and parking lot stopping location icon 88. A user may provide touch screen input to display 30 or may otherwise select between icons 84, 86, and 88 to pick a desired stopping location for vehicle 10. In response to selection of icon 84, control circuitry 18 will direct system 14 to stop vehicle 10 in front of entrance 78. In response to selection of icon 86, control circuitry 18 will direct system 14 to stop vehicle 10 in front of entrance 80. If the user selects icon 88, vehicle 10 will drive into parking lot 82 and will park in an available parking space.

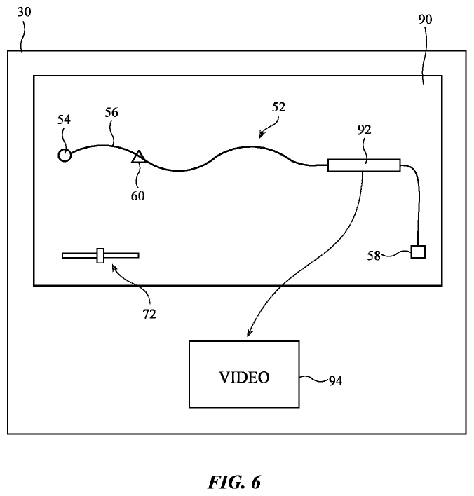

A user may direct application 22 to provide the user with traffic information along the user's route. Consider, as an example, the illustrative scenario of FIG. 6, in which application 22 is presenting interactive map 90 on display 30. Map 90 may include route 52. Route 52 may follow roadways on map 50 between starting point 54 and ending point 58, as represented by route line 56. Vehicle icon 60 may be located at a location along line 56 corresponding to the current location of vehicle 10. Highlighted segment 92 of line 56 may be presented to indicate that a corresponding portion of the user's route has heavy traffic. The user may desire additional information on the traffic conditions associated with segment 92. By selecting segment 92 (e.g., with touch input, etc.), the user may direct application 22 to present video of the road conditions for segment 92 and/or other associated media items (text and/or graphical information on expected wait times, information on bridge or tunnel closures and expected times of opening if closed, weather alerts, traffic descriptions, alternate route information, etc.). As shown in FIG. 6, for example, real-time video images of traffic in segment 92 may be presented in display region 94 in response to selection of segment 92 (as an example).

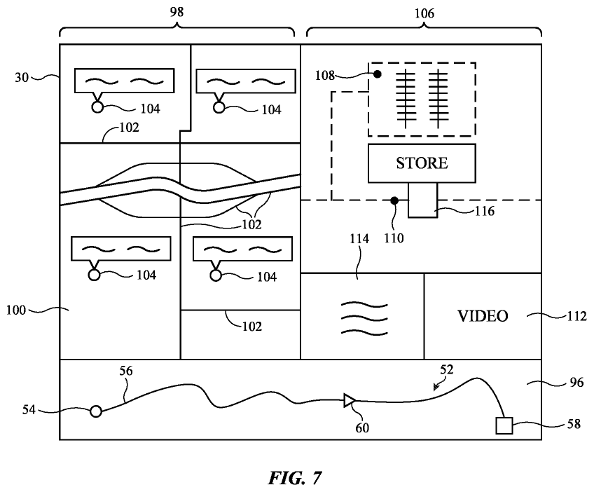

FIG. 7 shows an illustrative interactive map (map 96) that contains route 52. Supplemental information 98 may be presented on display 30 that corresponds to the currently selected location of vehicle icon 60 (which may correspond to a past location of vehicle 10 along route 52, the current location of vehicle 10 along route 52, or a future location of vehicle 10 along route 52). Information 98 may include, for example, local map 100, containing roadways 102 in the vicinity of a highway exit.

Map 100 may include annotated business icons 104 corresponding to restaurants, stores, and other entities within the boundaries of map 100. The user may select a desired business icon 104 for a business at a future location along route 52, thereby instructing control circuitry 18 to modify the current route to visit the business associated with the selected icon. Upon selecting a particular business to visit, associated business information 106 may be presented. Information 106 may include a local map of the selected business including selectable parking lot option 108 and selectable drive-through location option 110. Video of the current traffic associated with the drive-through window of the selected business may be presented in window 112. Restaurant menu items that may be purchased at the business or other items associated with the business may be presented in window 114. A user may select option 110 to direct the autonomous driving system of vehicle 10 to drive vehicle 10 to drive-through window 116 or may select option 108 to direct vehicle 10 to park in the parking lot associated with option 108.

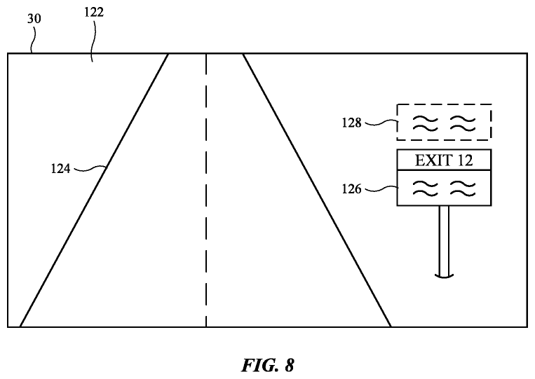

If desired, display 30 may be used to present still and/or moving images (video) of the road on which vehicle 10 travels. The images may include images gathered by the cameras of vehicle 10 as vehicle 10 passed along the road before reaching the vehicle's location. The images may also include database images corresponding to the user's route (e.g., past, present, and future portions of the route). As shown in FIG. 8, such images may include, for example, an image such as image 122 that contains the roadway associated with the user's route (road 124) and may include images of signs and other objects in the vicinity of road 124 (see, e.g., road sign 126). Signs such as sign 126 may include information on establishments at an upcoming exit and other points of interest along road 124. If desired, vehicle 10 may overlay computer-generated images such as virtual sign 128 on regions of image 122. Virtual sign 128 (or other indicator such as an icon, etc.) may include, for example, information on a business located at the upcoming exit. The user may use knob input or other input to navigate in forward or reverse through road images such as image 122 of FIG. 8. In this way, the user may browse along the upcoming route for potential places to stop or may review historical images of places the user has visited at earlier portions of the route.

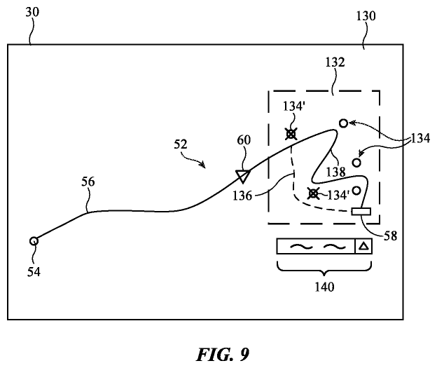

If desired, a local map may be presented to the user that shows points of interest near the end of the user's route or other local area of interest. As shown in FIG. 9, for example, interactive route map 130 may contain a local map such as local map 132. Local map 132 may be a magnified portion of map 130 that corresponds to streets in the vicinity of ending point 58 of route 52. Application 22 may automatically define the boundaries of local map 132 or a user may adjust the boundaries of local map 132 to select a roam zone along the user's route. Within the area corresponding to map 132, there may be various route options available (e.g., different local roads that can be used to complete route 52). A user may view annotated icons such as selectable icons 134 in map 130 and may decide that a subset of the business locations or other locations associated with icons 134 are of interest. The user may then select desired icons 134 (e.g., using touch input or other user input). In the example of FIG. 9, the user selected two icons 134′ among five available icons 134. In response to this selection, vehicle 10 may conclude that only icons 134′ are of interest and may therefore recalculate route 52 so that the local streets that correspond to dashed route segment 136 passing icons 134′ are used in place of initially selected local streets 138. By choosing among various optional locations to visit in this way, the user may shorten (or lengthen) route 52 to pass by locations of interest while excluding locations that are not of interest. If desired, the user may use a selectable option such as option 140 (e.g., a drop-down menu, etc.) to provide control circuitry 18 with a desired category of icon to display in local map 132. As an example, if the user is interested in viewing stores, the user may select a store category from option 140, so that the icons 134 that are displayed in map 132 are restricted to stores. Different categories and/or multiple categories may be selected, if desired.

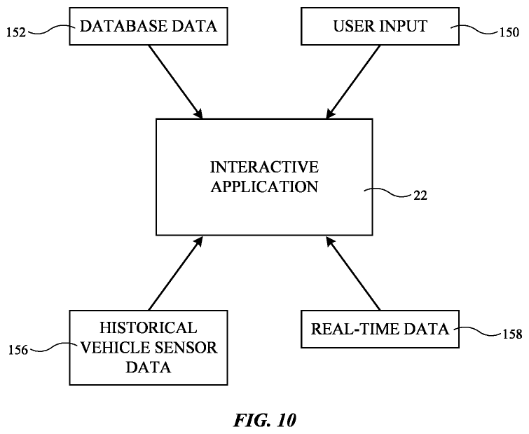

FIG. 10 is a diagram of illustrative operations involved in using vehicle 10. As shown in FIG. 10, data may be provided to applications such as interactive route map application 22 and/or other applications from one or more sources. Control circuitry 18 may be configured to implement application such as applications 20, 22, and 24 of FIG. 1. During operation, sensors and other systems 16 (e.g., knobs, sliding buttons, and other physical input devices, display edge sensors, touch screens, etc.) may gather user input 150. User input 150 may include, for example, knob rotations, slider movements, touch input (e.g., touch input to a display edge sensor or other touch sensor, touch input to touch sensor overlapping display 30, touch input to a stand-alone touch sensor, etc.), voice input, and other user input. Knob input such as counterclockwise and clockwise knob rotation input and/or other user input may be used to forward and reverse a virtual vehicle (e.g., vehicle icon 60) along a route in an interactive map presented on display 30.

Database data 152, historical vehicle sensor data 156, and real-time data 158 may be provided to a user with display 30 and/or other output devices in systems 16. For example, application 22 may gather media such as images, sound, and/or other output associated with the currently selected location of icon 60 along a route in an interactive map and may present such media using display 30, speakers, etc. The media may include interactive 360° images, sensor data gathered by sensors in vehicle 10 and stored for later retrieval (e.g., historical vehicle sensor data 156 such as captured images), sensor data gathered by cameras and other sensors in other vehicles, sensor data gathered by sensors that are not associated with a vehicle, and/or other sensor measurements (e.g., sensor data in database data 152), and real-time data such as real-time weather information, real-time traffic information, real-time video feeds from roadside cameras, real-time video from cameras in stores and other establishments, and/or other real-time data 158. Real-time data 158 may include local data gathered from sensors in vehicle 10 and remote data gathered from roadside sensors (e.g., traffic cameras), weather stations, and other remote sensors. The media may be presented on display 30 (e.g., in a local interactive map, in one or more regions of an interactive map that contains the user's current route, on a separate display screen, etc.).

In accordance with an embodiment, a vehicle is provided that includes a vehicle body having an interior region, a touch sensor configured to gather input and a display in the interior region that is configured to display a vehicle icon that is moved by the input to a position on a route that differs from where the vehicle body is currently located along the route.

In accordance with another embodiment, the touch sensor includes a display edge sensor.

In accordance with another embodiment, the display edge sensor is configured to receive the forward input and reverse input in response to sliding finger movements along the display edge sensor.

In accordance with another embodiment, the display is configured to display the vehicle icon at a position that is moved forward along the route in response to the forward input and that is moved backwards along the route in response to the reverse input.

In accordance with another embodiment, the display edge sensor includes a strip of touch sensor electrodes that extend along a peripheral edge of the display.

In accordance with another embodiment, the strip of touch sensor electrodes is configured to gather the forward input and the reverse input.

In accordance with another embodiment, the display edge sensor includes a strip of touch sensor electrodes extending along a peripheral edge of the display.

In accordance with another embodiment, the display edge sensor includes a first strip of touch sensor electrodes extending along a first peripheral edge of the display and a second strip of touch sensor electrodes extending along a second peripheral edge of the display that is orthogonal to the first peripheral edge of the display.

In accordance with another embodiment, the vehicle includes a knob configured to gather clockwise knob rotation input to move the vehicle icon forward along the route and counterclockwise knob rotation input to move the vehicle icon in reverse along the route.

In accordance with another embodiment, the vehicle includes a wireless transceiver configured to receive media associated with the position that is displayed on the display adjacent to the route.

In accordance with another embodiment, the vehicle includes storage configured to store media associated with the position that is displayed on the display adjacent to the route.

In accordance with another embodiment, the vehicle includes a wireless transceiver configured to receive a roadside image corresponding to the position on the route at which the vehicle icon is located.

In accordance with another embodiment, the vehicle includes a wireless transceiver configured to receive a 360° roadside image corresponding to the position on the route at which the vehicle icon is located.

In accordance with another embodiment, the vehicle includes storage configured to store a roadside image corresponding to the position on the route at which the vehicle icon is located.

In accordance with another embodiment, the vehicle includes storage configured to store a 360° roadside image corresponding to the position on the route at which the vehicle icon is located.

In accordance with another embodiment, the vehicle includes a wireless transceiver configured to receive real-time video corresponding to the position on the route at which the vehicle icon is located.

In accordance with another embodiment, the vehicle includes storage configured to store an interactive local map for the position on the route, the interactive local map includes a parking lot stopping option.

In accordance with an embodiment, a vehicle is provided that includes a vehicle body having an interior region, a knob configured to gather clockwise input and counterclockwise input and a display in the interior region that is configured to display a vehicle icon that is moved by at least one of the clockwise input and the counterclockwise input to a position on a route that differs from where the vehicle body is currently located along the route.

In accordance with another embodiment, the vehicle includes storage configured to store a road sign image associated with the position.

In accordance with another embodiment, the vehicle includes a camera configured to capture an image at the position, the display is configured to display the image.

In accordance with another embodiment, the vehicle includes a wireless transceiver configured to receive an image associated with the position, the display is configured to display the image.

In accordance with an embodiment, a vehicle is provided that includes a vehicle body, a sensor configured to gather input and a display configured to display an interactive map that contains autonomous vehicle stopping location options that are selected by the gathered input.

In accordance with another embodiment, the display is configured to display a driving route and is configured to move a vehicle icon along the driving route in response to the input.

In accordance with another embodiment, the sensor is configured to gather input selected from the group consisting of: knob rotation input, slider input, and touch sensor input and, in response to the input, the display is configured to display a route line for the route and to move the vehicle along the route line in response to the input.

The foregoing is merely illustrative and various modifications can be made to the described embodiments. The foregoing embodiments may be implemented individually or in any combination.

What is claimed is:

1. A vehicle, comprising:
a vehicle body having an interior region;
a touch sensor configured to gather input; and
a display in the interior region that is configured to display a vehicle icon that is moved by the input to a position on a route that differs from where the vehicle body is currently located along the route.

2. The vehicle defined in claim 1 wherein the touch sensor comprises a display edge sensor.

3. The vehicle defined in claim 2 wherein the display edge sensor is configured to receive the forward input and reverse input in response to sliding finger movements along the display edge sensor.

4. The vehicle defined in claim 3 wherein the display is configured to display the vehicle icon at a position that is moved forward along the route in response to the forward input and that is moved backwards along the route in response to the reverse input.

5. The vehicle defined in claim 4 wherein the display edge sensor comprises a strip of touch sensor electrodes that extend along a peripheral edge of the display.

6. The vehicle defined in claim 5 wherein the strip of touch sensor electrodes is configured to gather the forward input and the reverse input.

7. The vehicle defined in claim 2 wherein the display edge sensor comprises a strip of touch sensor electrodes extending along a peripheral edge of the display.

8. The vehicle defined in claim 2 wherein the display edge sensor comprises a first strip of touch sensor electrodes extending along a first peripheral edge of the display and a second strip of touch sensor electrodes extending along a second peripheral edge of the display that is orthogonal to the first peripheral edge of the display.

9. The vehicle defined in claim 1 further comprising a knob configured to gather clockwise knob rotation input to move the vehicle icon forward along the route and counterclockwise knob rotation input to move the vehicle icon in reverse along the route.

10. The vehicle defined in claim 1 further comprising a wireless transceiver configured to receive media associated with the position that is displayed on the display adjacent to the route.

11. The vehicle defined in claim 1 further comprising storage configured to store media associated with the position that is displayed on the display adjacent to the route.

12. The vehicle defined in claim 1 further comprising a wireless transceiver configured to receive a roadside image corresponding to the position on the route at which the vehicle icon is located.

13. The vehicle defined in claim 1 further comprising a wireless transceiver configured to receive a 360° roadside image corresponding to the position on the route at which the vehicle icon is located.

14. The vehicle defined in claim 1 further comprising storage configured to store a roadside image corresponding to the position on the route at which the vehicle icon is located.

15. The vehicle defined in claim 1 further comprising storage configured to store a 360° roadside image corresponding to the position on the route at which the vehicle icon is located.

16. The vehicle defined in claim 1 further comprising a wireless transceiver configured to receive real-time video corresponding to the position on the route at which the vehicle icon is located.

17. The vehicle defined in claim 1 further comprising storage configured to store an interactive local map for the position on the route, wherein the interactive local map comprises a parking lot stopping option.

18. A vehicle, comprising:
a vehicle body having an interior region;
a knob configured to gather clockwise input and counterclockwise input; and
a display in the interior region that is configured to display a vehicle icon that is moved by at least one of the clockwise input and the counterclockwise input to a position on a route that differs from where the vehicle body is currently located along the route.

19. The vehicle defined in claim 18 further comprising storage configured to store a road sign image associated with the position.

20. The vehicle defined in claim 18 further comprising a camera configured to capture an image at the position, wherein the display is configured to display the image.

21. The vehicle defined in claim 18 further comprising a wireless transceiver configured to receive an image associated with the position, wherein the display is configured to display the image.

22. A vehicle, comprising:
a vehicle body;
a sensor configured to gather input; and
a display configured to display an interactive map that contains autonomous vehicle stopping location options that are selected by the gathered input.

23. The vehicle defined in claim 22 wherein the display is configured to display a driving route and is configured to move a vehicle icon along the driving route in response to the input.

24. The vehicle defined in claim 23 wherein the sensor is configured to gather input selected from the group consisting of: knob rotation input, slider input, and touch sensor input and wherein, in response to the input, the display is configured to display a route line for the route and to move the vehicle along the route line in response to the input.
